(19) United States
(12) Patent Application Publication
(10) Pub. No.: US 2024/0235136 A1
(43) Pub. Date: Jul. 11, 2024

(54) ELECTRICAL RECEPTACLE APPARATUS

(71) Applicant: Soraya Mohamed, Toronto (CA)

(72) Inventor: Soraya Mohamed, Toronto (CA)

(21) Appl. No.: 18/152,207

(22) Filed: Jan. 10, 2023

(51) Int. Cl. H01R 25/00; H02J 4/00

(52) U.S. Cl. CPC H01R 25/006; H01R 25/003; H02J 4/00

(57) ABSTRACT

An electrical receptacle apparatus that is configured to provide a second electrical receptacle in a desired location on a wall where the structure does not have a conventional electrical receptacle installed thereinto. The present invention includes a first electrical receptacle having a housing with prong members extending outward from the rear wall thereof. The prong members are configured to be operably coupled with contact openings of a conventional electrical receptacle. The first electrical receptacle has a tube member operably coupled thereto wherein the tube member is further coupled to a second electrical receptacle distally located on the tube member. Wiring is present within the tube member that provides electrical coupling of the second electrical receptacle to the first electrical receptacle. The tube member is releasably secured to a wall surface between the first electrical receptacle and the second electrical receptacle.

### FIELD OF THE INVENTION

The present invention relates generally to electrical source configurations, more specifically but not by way of limitation, an electrical outlet appliance that is configured to be electrically coupled to a conventional electrical outlet wherein the present invention provides a first electrical outlet and a second electrical outlet that is distally mounted to the first electrical outlet.

### BACKGROUND

As is known in the art, conventional electrical wiring and device placement are routine and at a minimum dictated by local building codes. All commercial and residential structures are equipped with an electrical layout that includes devices such as but not limited to lights, switches and outlets. The layout for each building is executed both in accordance with a builders desired location of the aforementioned devices as well as compliance with local building codes. Once a structure is complete, it can be difficult and cost prohibitive to add certain devices such as but not limited to electrical outlets. Depending upon the need, an individual may require an electrical outlet to power an appliance but the construction of the area did not provide an electrical outlet in the needed location.

A common technique to address supplying power to an appliance can be to employ an extension cord. While this will suit the electrical needs, this solution is often undesirable from a cosmetic perspective and can further introduce safety hazards such as tripping. While re-wiring can be performed, this is often very costly and as such a user will elect to either forego the desired placement of the electrical appliance or employ a less desirable technique from a safety and decorative perspective. Additionally, utilization of conventional extension cord includes challenges in areas such as but not limited to mounting of the extension cord to a wall or other area along the routing pathway.

Accordingly, it is intended within the scope of the present invention to provide an electrical outlet apparatus that includes a first outlet and a second outlet wherein the first outlet is electrically coupled to a conventional outlet and the second outlet is electrically coupled thereto and distally located from the first outlet.

### SUMMARY OF THE INVENTION

It is the object of the present invention to provide an electrical outlet apparatus configured to provide a power source to a desired location wherein the present invention includes a first electrical receptacle and a second electrical receptacle.

Another object of the present invention is to provide an electrical outlet extension device that is operable to provide a power source in a desired location wherein the first electrical receptacle of the present invention is electrically coupled to a electrical receptacle present in a structure.

A further object of the present invention is to provide an electrical outlet apparatus configured to provide a power source to a desired location wherein the second electrical receptacle is electrically coupled to the electrical receptacle.

Still another object of the present invention is to provide an electrical outlet extension device that is operable to provide a power source in a desired location wherein the first electrical receptacle and second electrical receptacle have a malleable tubing coupled therebetween.

An additional object of the present invention is to provide an electrical outlet apparatus configured to provide a power source to a desired location wherein the second electrical receptacle is releasably secured to a suitable support surface such as but not limited to a wall.

Yet a further object of the present invention is to provide an electrical outlet extension device that is operable to provide a power source in a desired location wherein the malleable tubing has disposed therein wires providing the electrical coupling of the first electrical receptacle and second electrical receptacle.

Another object of the present invention is to provide an electrical outlet apparatus configured to provide a power source to a desired location wherein the malleable tubing is releasably secured to a wall or other support surface.

Still a further object of the present invention is to provide an electrical outlet extension device that is operable to provide a power source in a desired location wherein the present invention is provided in various colors and finishes.

Yet another object of the present invention is to provide an electrical outlet apparatus configured to provide a power source to a desired location wherein the first electrical receptacle includes prong members on the rear of the housing thereof.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the present invention; and

FIG. 2 is a side view of the first electrical receptacle of the present invention; and

FIG. 3 is a front view of the first electrical receptacle of the present invention.

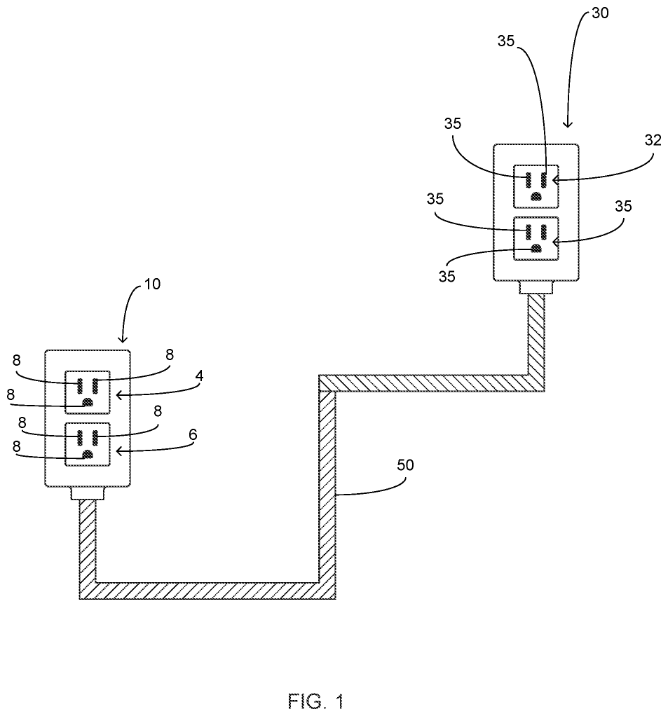

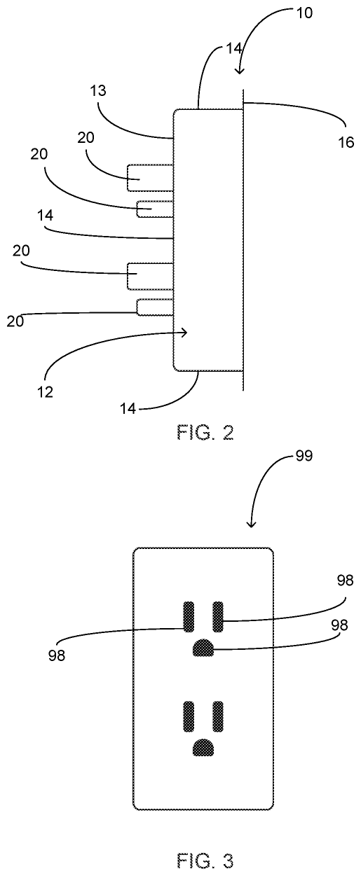

### DETAILED DESCRIPTION

Referring now to the drawings submitted herewith, wherein various elements depicted therein are not necessarily drawn to scale and wherein through the views and figures like elements are referenced with identical reference numerals, there is illustrated an electrical receptacle apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures submitted herewith, the electrical receptacle apparatus 100 includes a first electrical receptacle 10 and a second electrical receptacle 30 operably coupled with a tube member 50. While not particularly illustrated herein, it should be understood within the scope of the present invention that the tube member 50 has disposed therein conventional electrical wiring that is operable to electrically couple the first electrical receptacle 10 with the second electrical receptacle 30.

The first electrical receptacle 10 includes a housing 12 consisting of a plurality of walls 14 that are integrally formed to create an interior volume. The housing 12 is rectangular in shape having a faceplate 16 secured to the front side thereof. While the housing 12 and faceplate 16 are illustrated herein as being rectangular in shape, it is contemplated within the scope of the present invention that the housing 12 and faceplate 16 could be provided in alternate shapes. The first electrical receptacle 10 includes prong members 20 that extend outward from the rear wall 13 of the housing 12. The prong members 20 are manufactured from metal and are provided in an arrangement so as to be journaled into the contact openings 98 of the exemplary electrical receptacle 99. Illustrated herein in FIG. 3 is a conventional one hundred and twenty volt electrical receptacle 99. The exemplary electrical receptacle 99 is mounted within a structure in a location complaint with building and/or electrical codes. The prong members 20 extend rearward from the housing 12 and are journaled into the contact openings 98 of the exemplary electrical receptacle 99. Ensuing operable connection with the exemplary electrical receptacle 99, the first electrical receptacle 10 and the contact openings 8 thereof are electrically coupled to the exemplary electrical receptacle 99 allowing for use thereof to operably coupled a desired electrical appliance. The contact openings 8 are arranged in a first contact opening group 4 and a second contact opening group 6 so as to receive a conventional one hundred and twenty volt plug.

A tube member 50 is operably coupled to the first electrical receptacle 10 and the second electrical receptacle 30. It should be understood that the tube member 50 could be provided in alternate lengths and diameters. In a preferred embodiment the tube member 50 is manufactured from flexible metal gooseneck tubing. The tube member 50 can be releasably secured to a wall surface present between the first electrical receptacle 10 and second electrical receptacle 30. It is contemplated within the scope of the present invention that the tube member 50 could be releasably secured to a wall surface utilizing a plurality of conventional elements and techniques. By way of example but not limitation, the tube member 50 could be releasably secured to a magnetized sticker that has been adhered to the wall surface.

The second electrical receptacle 30 is secured to a wall surface utilizing desired techniques such as but not limited to pressure sensitive adhesive. It should be understood within the scope of the present invention that the second electrical receptacle 30 is mounted onto the surface of a wall as opposed to being mounted into the wall as is with conventional receptacles. The second electrical receptacle 30 includes a first contact opening group 32 and a second contact opening group 34 having contact openings 35 arranged to electrically couple with a conventional one hundred and twenty volt plug of an appliance. While the second electrical receptacle 30 is illustrated as being rectangular in shape herein, it is contemplated within the scope of the present invention that the second electrical receptacle 30 could be provided in alternate shapes and sizes. Additionally, while the electrical receptacle apparatus 100 has been illustrated and discussed herein to be electrically coupled to a one hundred and twenty volt electrical source, it is contemplated that the electrical receptacle apparatus 100 could be configured for a two hundred and forty electrical source having the contact opening arrangements and prong members required to provide the operable coupling.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An electrical receptacle apparatus that is configured to place an electrical receptacle onto a wall surface wherein the electrical receptacle apparatus comprises:
a first electrical receptacle, said first electrical receptacle having a housing, said housing having a plurality of walls forming an interior volume, said first electrical receptacle having a first prong member group and a second prong member group, said first prong member group and said second prong member group extending outward from a rear wall of said housing, said first prong member group and said second prong member group configured to be electrically coupled to contact openings of an electrical outlet, said first electrical receptacle having a first contact opening group and a second contact opening group on a front thereof;
a second electrical receptacle, said second electrical receptacle being electrically coupled to said first electrical receptacle, said second electrical receptacle having a housing, said housing having a plurality of walls forming an interior volume, said second electrical receptacle having a first contact opening group and a second contact opening group on a front thereof, said second electrical receptacle configured to be superposed a wall surface; and
a tube member, said tube member being hollow having a wire therein wherein said wire provides electrical coupling of said first electrical receptacle and said second electrical receptacle, said tube member having a first end and a second end, said first end of said tube member being operably coupled to said housing of said first electrical receptacle, said second end of said tube member being operably coupled to said second electrical receptacle.

2. The electrical receptacle apparatus that is configured to place the electrical receptacle onto a wall surface as recited in claim 1, wherein said tube member is releasably secured to a wall surface between said first electrical receptacle and said second electrical receptacle.

3. The electrical receptacle apparatus that is configured to place the electrical receptacle onto a wall surface as recited in claim 2, wherein the tube member is manufactured from metal gooseneck tubing.

4. The electrical receptacle apparatus that is configured to place the electrical receptacle onto a wall surface as recited in claim 3, wherein the electrical receptacle apparatus is configured to operably couple with a one hundred and twenty volt power source.

5. The electrical receptacle apparatus that is configured to place the electrical receptacle onto a wall surface as recited in claim 3, wherein the electrical receptacle apparatus is configured to operably couple with a two hundred and forty volt power source.
